(19) United States
(12) Patent Application Publication
(10) Pub. No.: US 2014/0097608 A1
(43) Pub. Date: Apr. 10, 2014

(54) INFORMATION ACQUISITION AND READOUT USING A TACTILE AUGMENTED LABEL

(71) Applicants: Elizabeth Ann Buzhardt, Nashville, TN (US); Mary Catherine Buzhardt, Nashville, TN (US)

(72) Inventors: Elizabeth Ann Buzhardt, Nashville, TN (US); Mary Catherine Buzhardt, Nashville, TN (US)

(21) Appl. No.: 13/647,312

(22) Filed: Oct. 8, 2012

(51) Int. Cl. B42D 15/10; B31D 5/00

(52) U.S. Cl. CPC B42D 15/10; B31D 5/00
USPC 283/70; 283/81; 493/320

(57) ABSTRACT

A device and a method are disclosed including a tactile augmented information label or printed matter configured to allow tactile detection of the proximity of non-tactile information on the printed label or printed matter and to enable acquisition of such information using a computing device, such as a smartphone equipped with an optical input device, for example, a camera. In various embodiments the optically acquired information may be converted to speech and be read out to a user of the computing device to assist a visually challenged or impaired user or a user in dim light. Additionally, such acquired information may be presented to the user, for example on the smartphone, in other usable forms such as in large print, different fonts, different colors, lighted or backlit print, and the like.

### TECHNICAL FIELD

This application relates generally to information accessibility. More specifically, this application relates to using a label with a tactile identifier to acquire and/or read out the information contained on the label.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example application of a smartphone scanning a tactile augmented barcode label and converting the information to speech;

FIG. 4A shows an example tactile augmented barcode label and its components;

FIG. 4B shows an example tactile augmented text label and its components; and

FIG. 5 shows an example tactile augmented multi section text label and its components.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references barcode labels, it will be appreciated that the disclosure may be used with other types of labels and information such as text labels, images, printed information like books and magazines, logos, and the like.

Briefly described, a device and a method are disclosed including a tactile augmented information label or printed matter configured to allow tactile detection of the proximity of non-tactile information on the printed label or printed matter and to enable acquisition of such information using a computing device, such as a smartphone equipped with an optical input device, for example, a camera. In various embodiments the optically acquired information may be converted to speech and be read out to a user of the computing device to assist a visually challenged or impaired user or a user in dim light. Additionally, such acquired information may be presented to the user, for example on the smartphone, in other usable forms such as in large print, different fonts, different colors, lighted or backlit print, and the like.

Most products are labeled according to applicable laws and also for the purpose of informing the users about the features of the products. For example, all processed food packaging are required by law to have labels listing the ingredients in the food and other nutritional information, in addition to preparation information for some food items. Other non-food articles, such as clothing, tools, household products, business products, automotive products, and the like also have informative labels which provide product features as well as marketing information. To include as much information on a small space provided by labels as possible, many labels have very small print which are difficult to read even in good light. For the visually limited or impaired and also in dim light, such labels may be almost impossible to read. Additionally, many labels have multiple sections which include different types of information. For example, a food package may have a section for ingredients and another section for preparation instructions.

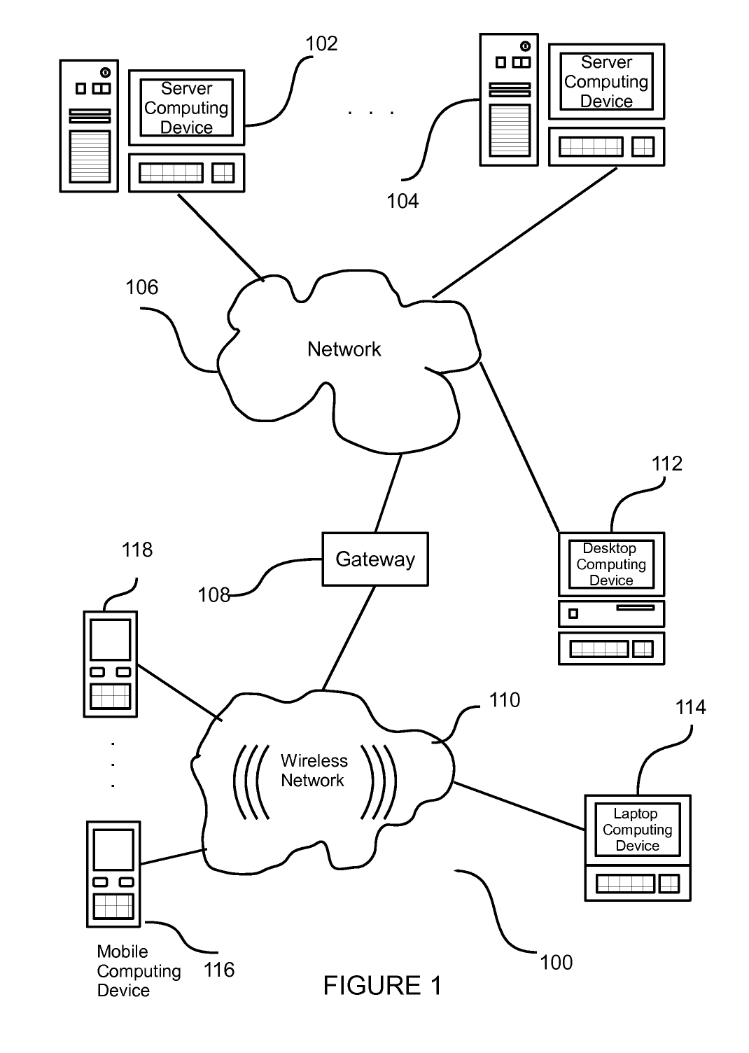

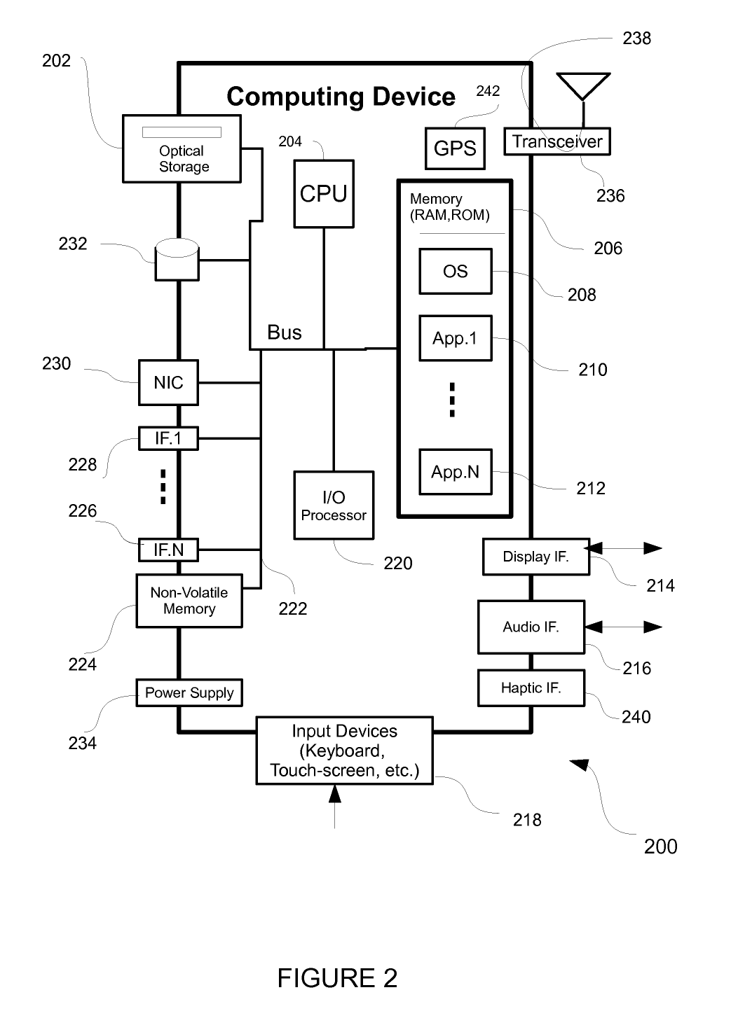

With the advent of smartphones, many software applications running on the smartphones, often referred to as “apps,” are available which may assist users in performing many common and day to day tasks, such as finding gas stations, restaurants, searching the world wide web, taking notes, taking pictures, scanning documents, and the like. The computing and optical features of smartphones or similar devices, further described below with respect to FIGS. 1 and 2 below, may be used to read the labels for the visually impaired or under dim light conditions.

### Illustrative Operating Environment

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, digital cameras, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, and the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4^{th} (4G), generation and any future generation technologies for radio access for cellular systems, WLAN, Wireless Router (WR) mesh, and the like. Access technologies such as 3G, 4G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs 210-212. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client communication operating system such as Windows Mobile™, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), HDMI (High Definition Multimedia Interface), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

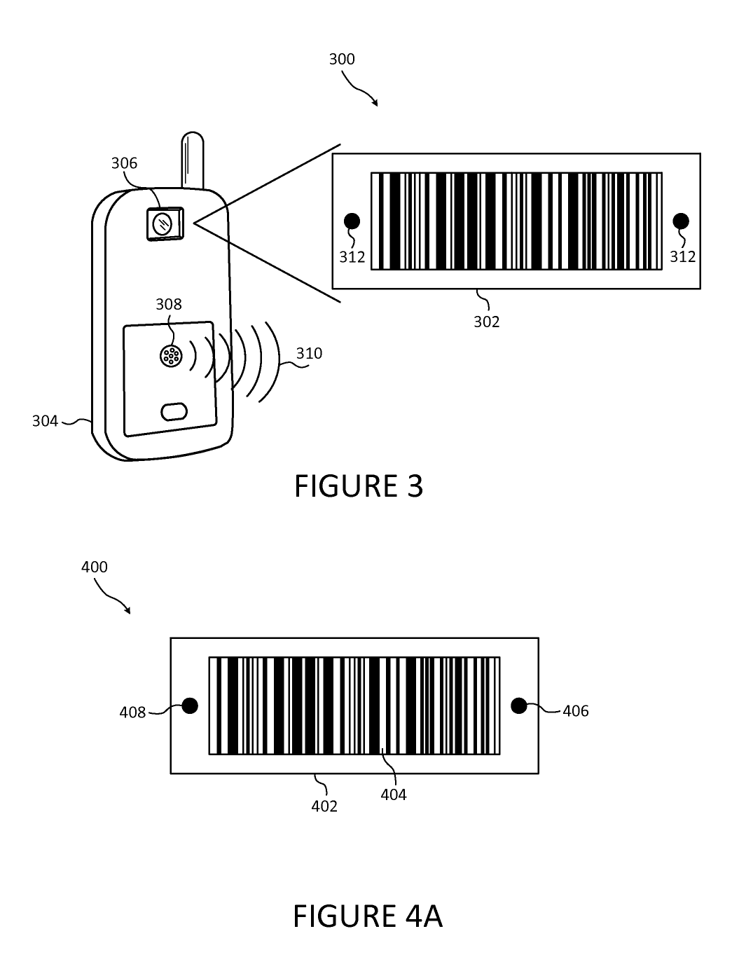

FIG. 3 shows an example application of a smartphone 304 scanning a tactile augmented barcode label 302 and converting the information to speech. In various embodiments, label scanning arrangement 300 includes tactile augmented barcode label 302 scanned by camera 306 of smartphone 304 and scanned information spoken via speaker 308 in the form of sound waves 310.

In various embodiments, a visually impaired user touches label 302 to find tactile bumps 312, such as Braille dots or bumps, in proximity of the label, for example, on two or four opposite sides of the label. The user may then point his smartphone equipped with a visual device, such as built-in camera 306, to scan the area near the tactile bumps 312. An application software (“app”) running on smartphone 304 scans the barcode 302 and captures the information encoded by the barcode lines. Such information may include name of a product, name of a manufacturer of the product, price, model number, and the like. The smartphone app may convert the acquired information to speech 310 and output the sound through speaker 308. In some embodiments, the speech is substantially simultaneous with the scanning of the label, while in other embodiments, the scanned information may be stored and converted to speech later. In yet other embodiments, the acquired information may be presented to the user in a different form such as in large print, different fonts, different colors, lighted or backlit print, and the like to allow the user to more easily read the same information.

In various embodiments, label 302 may include or be in the form of a paper substrate, a plastic substrate, a fabric substrate, or other similar material suitable for printing a label.

In some embodiments, the label may include symbolic contents such as barcode lines, shapes, symbols, commercial logos, text, images, color codes, and the like, or any combination of the aforementioned label contents. In addition to labels, the tactile augmented printed matter may include brochures, booklets, plaques, or any other printed surface which may be difficult for a user to read directly.

In various embodiments, the tactile features on the printed information may include Braille bumps, texture changes, ridges, or any other tactile feature which may be easily differentiated by sense of touch from the rest of the label or printed matter. In some embodiments, the tactile features may be an integral part of the label substrate, for example, by embossing the tactile features on the substrate, while in other embodiments, the tactile features may be added and affixed externally, such as by printing or gluing on the surface of the label substrate.

In various embodiments, the tactile features may or may not include any encoded information of its own. For example, if Braille bumps or dots are used, the bump configuration may itself convey some textual information, such as “Ingredients” on a food label. Alternatively, the bumps may not encode any particular information but only serve to identify the proximity or location of other written, non-tactile information, such as printed text. In still other embodiments, the tactile features may include both types of information, namely encoded and proximity information. In some embodiments, the Braille bumps or tactile features may include encoded information which is different and distinct from the symbolic information printed on the label.

In various embodiments, the tactile features may surround an area of text to identify not only the proximity of the printed text or information, but also the boundaries on several sides, for example, on four sides of a label. This way, the user may feel, by touch, where the label is and then use this proximity and boundary information to scan the area enclosed within the tactile features with his smartphone or other similar scanning device. In still other embodiments, the tactile feature may be in the form of a raised or otherwise tactile boundary line all around a printed are to be scanned.

In still other various embodiments, several different tactile features may be used to identify different types of labels or different sections within the label. Such different tactile features may be standardized in several categories such as “Directions for Use,” “Contents” or “Ingredients,” “Price,” “Brand Name” or “Manufacturer,” and the like. So, for each predefined tactile feature category, a different tactile feature may be used which may be defined which may be readily identified by the user. For example, a single bump may be used to identify a first category, while two bumps may be used to identify a second category. This way, for example, when a user is only looking for price or brand name, she does not have to read all printed text to obtain the small subset of information she is looking for. She can quickly identify the section of the label which has the price and the brand name information and only scan those areas.

Such tactile augmented labels or printed matter may be used in many areas of daily life, such as medicine bottles and packages, various product labels, restaurant menus, instruction sheets, advertising leaflets, and the like.

In various embodiments, the tactile features may be implemented using paper embossment, printed pattern using raised ink, textured material such as a textured tape segment, and the like.

In various embodiments, the tactile features may be integrated with or deployed on the label substrate, while in other embodiments, the tactile features may be constructed and deployed separately on a product in close proximity to the label affixed to the same product such that the tactile features may be substantially used as if the tactile features were deployed onto the label substrate.

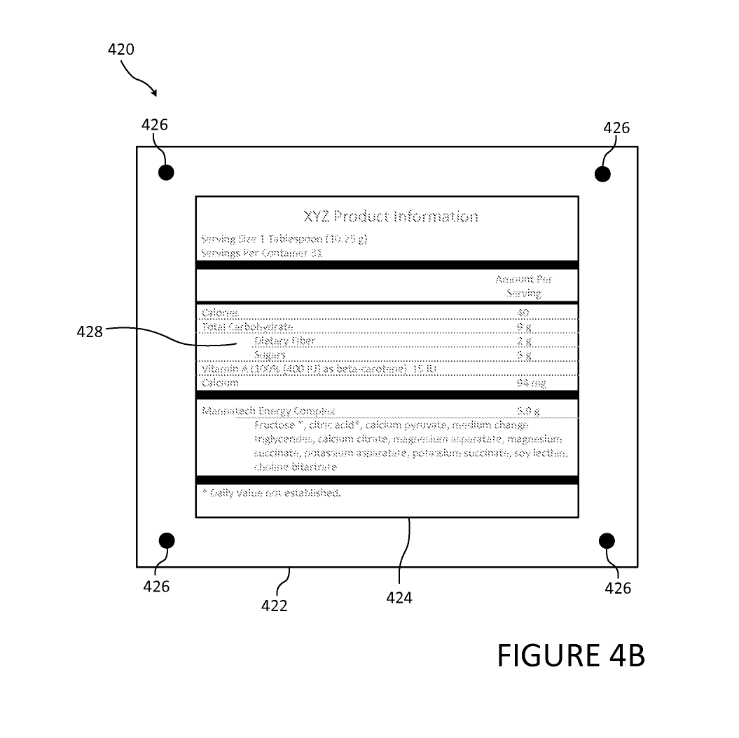

FIG. 4A shows an example tactile augmented barcode label 400 and its components. In various embodiments, barcode label 400 includes substrate 402, barcode 404, and boundary bumps 406 and 408. In various embodiments, substrate 402 is affixed to a product surface or package and the boundary bumps 406 and 408 are used to identify the proximity and/or boundaries of barcode 404 for scanning and presentation to the user using a smartphone or other similar device, as described above with respect to FIG. 3. In various embodiments, substrate 402 may be made of paper, plastic, cloth, sheet metal, carbon fiber, or other similar material suitable for affixing to a surface.

FIG. 4B shows an example tactile augmented text label and its components. In various embodiments, text label 420 includes substrate 422, content area 424, information content 428, and boundary bumps 426. In various embodiments, label 420 is affixed to a product surface or package and the boundary bumps 426 are used to identify the proximity and/or boundaries of content area 424 for scanning and presentation to the user using a smartphone 304 or other similar device, as described above with respect to FIG. 3.

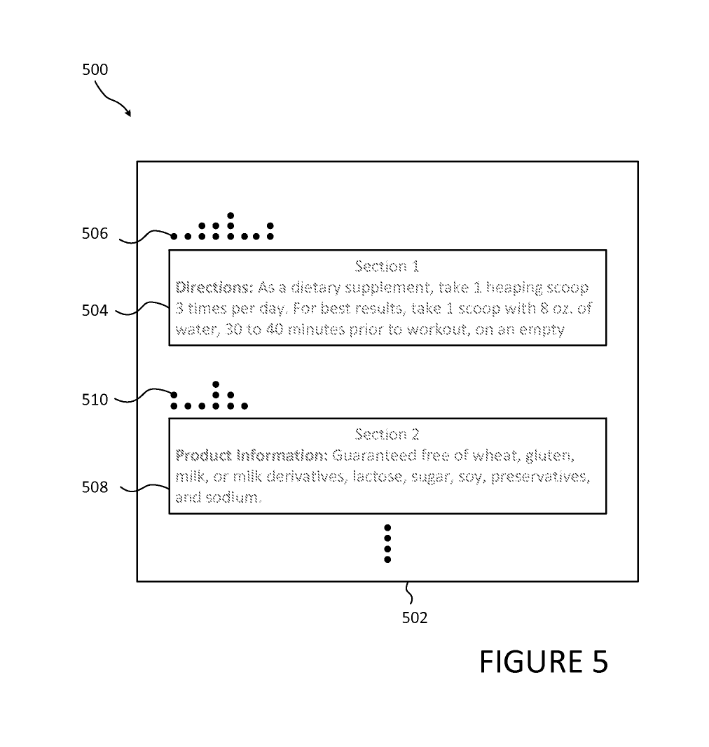

FIG. 5 shows an example tactile augmented multi section text label and its components. In various embodiments, label or printed matter 500 includes substrate 502, separate content sections 504 and 508, and tactile features 506 and 508 for identification and locating of content sections 504 and 508, respectively. In various embodiments, printed matter 500 is affixed to a product surface or package, or acquired for reading as a standalone brochure or similar information source, and the tactile features 506 and 510 are used to identify the proximity and/or boundaries of content sections 504 and 508, respectively, for scanning and presentation to the user using a smartphone 304 or other similar device, as described above with respect to FIG. 3.

It will be understood that some or all of the processes discussed above may be implemented by computer program instructions. These program instructions may be provided to a processor to produce a machine, such that the instructions, which execute on the processor, create means for implementing the actions specified in the process. The computer program instructions may be executed by a processor to cause a series of operational steps to be performed by the processor to produce a computer implemented process such that the instructions, which execute on the processor to provide steps for implementing the actions specified in the process. The computer program instructions may also cause at least some of the operational steps shown in the processes. Moreover, some of the steps may also be performed across more than one processor, such as might arise in a multi-processor computer system. In addition, one or more steps in the processes may also be performed concurrently with other steps or even in a different sequence than described without departing from the scope or spirit of the disclosure.

Accordingly, steps in the processes described support combinations of means for performing the specified actions, combinations of steps for performing the specified actions and program instruction means for performing the specified actions. It will also be understood that each step in the processes described, and combinations of steps, can be implemented by special purpose hardware based systems which perform the specified actions or steps, or combinations of special purpose hardware and computer instructions.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

1. A printed matter comprising:
a substrate;
a tactile feature deployed on the substrate;
symbolic content printed on the substrate; and
wherein the tactile feature is configured to at least identify a proximity of the symbolic content by sense of touch to lead a visually impaired person to the printed symbolic content and enable the person to approach and decipher the printed symbolic content.

2. The printed matter of claim 1, wherein the substrate is made from at least one of paper, plastic, fabric, and metal sheet.

3. The printed matter of claim 1, wherein the tactile feature is a Braille bump.

4. The printed matter of claim 1, wherein the printed matter includes one or more tactile feature, configured to identify boundaries of the symbolic content to be scanned and deciphered by an electronic device or by a smartphone equipped with a visual device which later may be converted to speech.

5. The printed matter of claim 1, wherein the tactile feature is configured to identify boundaries of the symbolic content.

6. The printed matter of claim 1, wherein the tactile feature does not include encoded information.

7. The printed matter of claim 1, wherein the tactile feature includes encoded information distinct from the symbolic content and wherein the encoded information of the tactile feature classifies the information content of the symbolic information.

8. The printed matter of claim 1, wherein the symbolic content includes one or more of text, image, logo, barcode, and symbols.

9. The printed matter of claim 1, wherein the printed matter includes a plurality of separate sections.

10. A method of enabling a visually impaired person to find a desired non-tactile information on a label, the method comprising:
creating a label;
printing symbolic information on the label; and
deploying at least one tactile feature on the label, wherein the tactile feature is configured to at least identify a proximity of the symbolic information by sense of touch and enable the visually impaired person to approach and decode the printed symbolic information.

11. The method of claim 10, further comprising coupling the label with a product.

12. The method of claim 10, wherein the symbolic information includes a barcode.

13. The method of claim 10, wherein the tactile feature comprises a Braille bump.

14. The method of claim 10, wherein the tactile feature includes encoded information distinct from the symbolic information.

15. The method of claim 10, wherein the symbolic information is printed in a plurality of separate sections on the label.

16. The method of claim 15, wherein the tactile feature is configured to identify a particular section of the plurality of separate sections.

17. A method of labeling a product, the method comprising:
providing a label including printed symbolic information and at least a tactile feature;
configuring the at least one tactile feature to at least identify a proximity of the symbolic information by sense of touch; and
affixing the label and the at least one tactile feature to the product or a product packaging to enable a visually impaired person to find and decipher the printed symbolic information.

18. The method of claim 17, wherein the at least one tactile feature classifies the information content of the symbolic information.

19. The method of claim 17, wherein the symbolic information is configured to be identified by the at least one tactile feature and scanned by a smartphone.

20. The method of claim 17, wherein the tactile feature comprises a Braille bump.
